(19) United States
(12) Patent Application Publication
(10) Pub. No.: US 2025/0343312 A1
(43) Pub. Date: Nov. 6, 2025

(54) DEVICE, SYSTEM, AND METHOD FOR PARALLEL CHARGING STACKED BATTERY PACKS

(71) Applicant: Core SWX, LLC, Plainview, NY (US)

(72) Inventor: Ross Kanarek, Plainview, NY (US)

(73) Assignee: Core SWX, LLC, Plainview, NY (US)

(21) Appl. No.: 19/265,191

(22) Filed: Jul. 10, 2025

Related U.S. Application Data
(63) Continuation-in-part of application No. 19/086,836, filed on Mar. 21, 2025.
Application No. 19/086,836 is a continuation-in-part of application No. 18/678,029, filed on May 30, 2024, now Pat. No. 12,261,475.
Application No. 18/678,029 is a continuation-in-part of application No. 18/632,097, filed on Apr. 10, 2024, now Pat. No. 12,095,291.
(60) Provisional application No. 63/573,527, filed on Apr. 3, 2024.

(51) Int. Cl. H01M 50/269; H01M 10/42; H01M 50/247; H01M 50/258; H02J 7/00

(52) U.S. Cl. CPC H01M 50/269; H01M 10/425; H01M 50/247; H01M 50/258; H02J 7/0013; H02J 7/0063; H01M 2220/30

(57) ABSTRACT

A battery pack includes a first mechanical connection, a first electrical connection, a DC input power port, a DC output power port, and an AC output power port. The first mechanical connection is configured to mechanically couple to a mechanical connection of an adjacent battery pack. The first electrical connection is configured to electrically couple to an electrical connection of the adjacent battery pack. The DC input power port is configured to allow charging form a DC power source. The DC output power port is configured provide power to a DC-based device. The AC output power port is configured to provide power to an AC-based device.

### CROSS-REFERENCE TO RELATED APPLICATIONS

The present U.S. Patent Application is a Continuation-In-Part of U.S. Non-Provisional patent application Ser. No. 19/086,836, filed on Mar. 21, 2025, which is a Continuation-In-Part of U.S. Non-Provisional patent application Ser. No. 18/678,029, filed on May 30, 2024,now U.S. Pat. No. 12,261,475 issued on Mar. 25, 2025, which is a Continuation-In-Part of U.S. patent application Ser. No. 18/632,097, filed on Apr. 10, 2024, now U.S. Pat. No. 12,095,291 issued on Sep. 17, 2024, which claims priority to U.S. Provisional Patent Application No. 63/573,527, filed on Apr. 3, 2024, the entire contents of each of which are incorporated by reference herein.

### FIELD

The present disclosure relates to a battery pack and, more particularly, to a device, system, and method for parallel charging and discharging multiple stacked battery packs.

### BACKGROUND

In the dynamic landscape of the cinema accessory market, where production demands are constantly evolving alongside advancements in camera technology, the necessity for an accessory-based power management system has become increasingly evident. Unlike traditional power solutions tethered to specific devices, an independent accessory power management system offers versatility and flexibility to cater to the diverse power requirements of production accessories.

Such a system can address the potential limitations posed by device-centric power sources, such as V/G/B mount battery packs which attach to devices. These sources may prioritize powering the primary device, leaving limited capacity or incompatible voltage outputs for supporting ancillary accessories. By decoupling the power source from the device, an accessory-based power management system can provide dedicated power outputs tailored to the unique voltage and current requirements of various production accessories.

Furthermore, to meet the strenuous power-handling requirements of large camera rig systems with many accessories, multiple battery packs can be connected in parallel to increase the overall capacity and discharge capability of the system. However, conventional methods of parallel connection may involve the use of additional mounting hardware for battery packs or wired connections, which can be cumbersome, prone to wear and tear, and may require extensive maintenance.

### SUMMARY

The present disclosure provides a device, method and system for parallel connection of battery packs utilizing magnetic, mechanical, and/or electrical coupling mechanisms. Embodiments of the present disclosure facilitate the stacking of battery packs (e.g., cinematography battery packs) in a parallel configuration, allowing efficient electrical, mechanical, and data transfer connection between adjacent packs without the need for traditional wired connections. This approach may employ electrical connection pads and leaf spring-type connectors, enabling secure and reliable electrical contact while minimizing the complexity and weight associated with conventional wiring methods, while also avoiding the use of pins which can misalign and break.

By paralleling multiple battery packs, users can extend runtime and power capacity to meet the demands of prolonged use and/or power-hungry accessories. Additionally, the ability to hot-swap depleted battery packs with fully charged battery packs allows for uninterrupted workflow continuity, eliminating downtime associated with battery recharging.

Incorporating DC input power ports and DC output power ports into the battery packs and system described herein adds another dimension of convenience and versatility. The DC power ports allow flexible powering of DC-based external devices and charging of the battery packs from DC power sources. Further, incorporating an internal inverter into the battery packs enables the battery packs and system to convert stored DC energy from the battery packs into the AC output power port, thereby allowing powering of AC-based external devices.

The stackable design further enhances this functionality, allowing users to charge and utilize multiple battery packs simultaneously to optimizing workflow efficiency.

The devices, system, and method described herein represents a transformative solution designed to meet the needs of various industries. For instance, a field technician performing equipment inspections could simultaneously power a DC-operated inspection camera and an AC-powered laptop from a single battery pack or system. Additionally, an emergency response team could utilize the disclosed battery system or battery pack to run both communications radios, which often require DC power, and a lighting system, which often requires AC power, during an operation.

Provided in accordance with aspects of the present disclosure is a battery pack. The battery pack includes a first mechanical connection, a first electrical connection, a DC input power port, a DC output power port, and an AC output power port. The first mechanical connection is configured to mechanically couple to a mechanical connection of an adjacent battery pack. The first electrical connection is configured to electrically couple to an electrical connection of the adjacent battery pack. The DC input power port is configured to allow charging from a DC power source. The DC output power port is configured to provide power to a DC-based device. The AC output power port is configured to provide power to an AC-based device.

In an aspect of the present disclosure, the first electrical connection automatically electrically couples to the electrical connection of the adjacent battery pack upon the first mechanical connection mechanically engaging the mechanical connection of the adjacent battery pack.

In an aspect of the present disclosure, the first mechanical connection includes at least one magnet.

In an aspect of the present disclosure, the first mechanical connection includes at least one latch.

In an aspect of the present disclosure, the at least one latch is movable between a first position where the at least one latch is recessed below a surface of the battery pack, and a second position where at least a portion of the at least one latch protrudes from the surface of the battery pack.

In an aspect of the present disclosure, the battery pack includes a second mechanical connection configured to mechanically couple to another mechanical connection of the adjacent battery pack. The second mechanical connection includes at least one magnet.

In an aspect of the present disclosure, the battery pack is a cinematography battery pack.

In an aspect of the present disclosure, the battery pack includes a power inverter configured to convert stored DC energy into AC output.

In an aspect of the present disclosure, the battery pack includes an additional power port. The additional power port is a DTAP port or a USB port.

Provided in accordance with aspects of the present disclosure is a battery system including a first battery pack and a second battery pack. The first battery pack includes a first mechanical connection, a first electrical connection, a DC input power port, a DC output power port, and an AC output power port. The DC input power port is configured to allow charging from a DC power source. The DC output power port is configured to provide power a DC-based device. The AC output power port is configured to provide power to an AC-based device. The second battery includes a second mechanical connection, a second electrical connection, a DC input power port, a DC output power port, and an AC output power port. The second mechanical connection is configured to mechanically couple to the first mechanical connection of the first battery pack. The second electrical connection is configured to electrically couple to the first electrical connection of the first battery pack. The DC input power port is configured to allow charging from a DC power source. The DC output power port is configured to provide power to a DC-based device. The AC output power port is configured to provide power to an AC-based device.

In an aspect of the present disclosure, the first battery pack and the second battery pack are configured to charge in parallel when the first battery pack and the second battery pack are mechanically coupled and electrically coupled with each other.

In an aspect of the present disclosure, the first electrical connection of the first battery pack automatically electrically couples to the second electrical connection of the second battery pack upon the first mechanical connection of the first battery pack mechanically engaging the second mechanical connection of the second battery pack.

In an aspect of the present disclosure, the first mechanical connection of the first battery pack includes at least one magnet, and the second mechanical connection of the second battery pack includes at least one magnet.

In an aspect of the present disclosure, the first mechanical connection of the first battery pack includes at least one latch, and the second mechanical connection of the second battery pack includes at least one latch receiver.

In an aspect of the present disclosure, the at least one latch is movable between a first position where the at least one latch is recessed below a surface of the first battery pack, and a second position where at least a portion of the at least one latch protrudes from the surface of the first battery pack.

In an aspect of the present disclosure, the at least one latch of the first battery pack is configured to mechanically engage the latch receiver of the second battery pack when the at least one latch is in the second position.

In an aspect of the present disclosure, the first mechanical connection of the first battery pack includes at least one latch, and the second mechanical connection of the second battery pack includes at least one latch receiver. Additionally, the first battery pack includes a third mechanical connection configured to mechanically couple to a fourth mechanical connection of the second battery pack. The third mechanical connection includes at least one magnet, and the fourth mechanical connection includes at least one magnet.

In an aspect of the present disclosure, the first battery pack is a cinematography battery pack, and the second battery pack is a cinematography battery pack.

In an aspect of the present disclosure, each of the first battery pack and the second battery pack includes a power inverter configured to convert stored DC energy into AC output.

In an aspect of the present disclosure, each of the first battery pack and the second battery pack includes an additional power port. The additional power port is a DTAP port or a USB port.

### BRIEF DESCRIPTION OF THE DRAWINGS

Various aspects and features of the present disclosure are described hereinbelow with reference to the drawings wherein:

FIG. 1 is a front, perspective view of a cinematography battery pack configured for parallel charging and discharging with another cinematography battery pack according to aspects of the present disclosure;

FIG. 2 is a rear, perspective view of the cinematography battery pack of FIG. 1;

FIG. 3 is a side view of two stacked cinematography battery packs of a system for parallel charging and discharging of multiple cinematography battery packs according to aspects of the present disclosure;

FIG. 4 is a side view of the two stacked cinematography battery packs of FIG. 3 in a separated arrangement;

FIG. 5 is a side view of the cinematography battery pack of FIG. 1 coupled with a fastening plate according to aspects of the present disclosure;

FIG. 6 is a rear, perspective view of the cinematography battery pack and the fastening plate of FIG. 5 in a separated arrangement;

FIG. 7 is a rear, perspective view of the fastening plate of FIG. 5;

FIG. 8 is a perspective view of a set of three stacked cinematography battery packs connected with a power cable according to aspects of the present disclosure;

FIG. 9 is a front, perspective view of two stacked cinematography battery packs with one of the stacked cinematography battery packs connected with a USB-C power cable and a DTAP power cable according to aspects of the present disclosure;

FIG. 10 is a front, perspective view of a single cinematography battery pack connected with a USB-C power cable and a DTAP power cable according to aspects of the present disclosure;

FIG. 11 is a perspective view of a fastening plate coupled to a cinematography camera configured to mate with an aligned cinematography battery pack according to aspects of the present disclosure;

FIG. 12 is a perspective view of the fastening plate and cinematography battery pack of FIG. 11 with the cinematography battery pack magnetically coupled with the fastening plate;

FIG. 13 is a front, perspective view of a fastening plate according to aspects of the present disclosure;

FIG. 14 is a rear, perspective view of the fastening plate of FIG. 13 shown with portions omitted;

FIG. 15 is a rear, perspective view of the fastening plate of FIG. 13 having a V-mount mechanical adapter, according to aspects of the present disclosure;

FIG. 16 is a rear, perspective view of the fastening plate of FIG. 13 having a G-mount mechanical adapter, according to aspects of the present disclosure;

FIG. 17 is a rear, perspective view of the fastening plate of FIG. 13 having a camcorder battery interface mechanical adapter, according to aspects of the present disclosure;

FIG. 18 is a front, perspective view of a cinematography battery pack having a mechanical connection, according to aspects of the present disclosure;

FIG. 19 is a rear, perspective view of the cinematography battery pack of FIG. 18, according to aspects of the present disclosure;

FIG. 20 is a side view of two cinematography battery packs of FIG. 18 adjacent each another, according to aspects of the present disclosure;

FIG. 21 is a side view of the cinematography battery pack of FIG. 18 mechanically engaged with a mounting plate, according to aspects of the present disclosure;

FIG. 22 is a rear, perspective of the cinematography battery pack of FIG. 18 spaced from the mounting plate of FIG. 21, according to aspects of the present disclosure;

FIG. 23 is a front, perspective view of the mounting plate of FIG. 21, according to aspects of the present disclosure;

FIG. 24 is a front, perspective view of a cinematography adapter, according to aspects of the present disclosure;

FIG. 25 is a side view of the cinematography battery pack of FIG. 18 mechanically engaged with the cinematography adapter of FIG. 24, according to aspects of the present disclosure;

FIG. 26 is a top view of the cinematography battery pack of FIG. 18 mechanically engaged with the cinematography adapter of FIG. 24, where a cross-section of the cinematography accessory is shown in phantom, according to aspects of the present disclosure; and

FIG. 27 is a perspective view of a set of three stacked battery packs where one of the battery packs includes a power cable connected thereto, according to aspects of the present disclosure.

### DETAILED DESCRIPTION

Descriptions of technical features or aspects of an exemplary configuration of the disclosure should typically be considered as available and applicable to other similar features or aspects in another exemplary configuration of the disclosure. Accordingly, technical features described herein according to one exemplary configuration of the disclosure may be applicable to other exemplary configurations of the disclosure, and thus duplicative descriptions may be omitted herein.

Exemplary configurations of the disclosure will be described more fully below (e.g., with reference to the accompanying drawings). Like reference numerals may refer to like elements throughout the specification and drawings.

The phrases “battery mount,” “mount plate,” and “battery mount plate” may be used interchangeably herein. The phrases “battery,” “battery pack,” “cinematography battery,” “cinematography battery pack,” and “pack” may be used interchangeably herein.

The present disclosure provides a device, system, and method for parallel connection of cinematography battery packs utilizing a magnetic coupling mechanism. The present disclosure facilitates the stacking of cinematography battery packs in a parallel configuration, allowing efficient electrical, mechanical, and/or data communication connection between adjacent cinematography battery packs without the need for wired connections.

In an aspect of the present disclosure, the device, system, and method employ electrical connection pads and leaf spring-type connectors, enabling secure and reliable electrical contact while minimizing the complexity and weight associated with conventional wiring methods, while also avoiding the use of pins which can misalign and break.

The incorporation of magnetic pads within the accessory-based power management device, system, and method according to the present disclosure incorporates an efficient method for aligning and securing cinematography battery packs during stacking while facilitating electrical, mechanical, and data transfer connections between the cinematography battery packs.

The magnetic/metal connection assembly described herein can be employed to align and secure cinematography battery packs to each other in a stacked arrangement. Each cinematography battery pack within the system may be equipped with magnetic pads strategically positioned along its edges or corners. These magnetic pads are designed to attract and align with corresponding magnetic pads on adjacent cinematography battery packs. The magnetic attraction enables precise alignment and secure stacking of the cinematography battery packs, eliminating the need for manual alignment or additional securing mechanisms.

The metal/magnetic pads of the magnetic connection assembly described herein may employ the two sets of pads on each pack that are not symmetrical, allowing for the packs to connect in only one direction.

In an aspect of the present disclosure, a mechanical push-button release assembly incorporated into each cinematography battery pack can be employed to disconnect connected cinematography battery packs from each other.

The device, system, and method described herein may employ an electrical pad/leaf spring connection. For example, in addition to the magnetic pads of the magnetic coupling assembly described herein, each cinematography battery pack may employe electrical pads and/or leaf spring connectors. These connectors may be integrated into the cinematography battery pack's structure and serve as the primary means of electrical connection between adjacent cinematography battery packs. For example, when two cinematography battery packs are stacked and aligned using the magnetic pads of the magnetic coupling assembly, the electrical pads or leaf spring connectors make contact with corresponding pads on the adjacent cinematography battery pack, establishing a secure electrical and/or data communication connection between two connected cinematography battery packs.

The device, system, and method described herein may employ a secondary fastening plate. While the cinematography battery packs themselves may include fastener attachments for securing the packs to mounting points or rigging systems, a secondary part may be utilized to increase the system's versatility. The secondary fastening plate may employ additional magnetic pads and attachment points. These additional attachment points provide users with greater flexibility in securing and mounting the cinematography battery packs with another structure or device (e.g., another cinematography battery pack, a cinematography apparatus such as a camera, lighting system, or another device powered by a cinematography battery pack. As an example, the secondary fastening plate may be employed in scenarios where multiple attachment points are required for stability or customization.

The magnetic connection assembly may employ opposing magnetic connection pads. The opposing magnetic connection pads may incorporate permanent magnets capable of generating sufficient attractive forces to provide secure alignment and contact between cinematography battery packs (e.g., magnetic forces requiring from about 1 pound to about 10 pounds of force to break).

The magnetic pads may employ polarization to facilitate proper orientation during stacking, thereby preventing misalignment.

The electrical connection assembly may employ reciprocally arranged leaf spring-type connectors or similar electrical contact elements arranged at one end of each cinematography battery pack. The electrical connectors of the electrical connection assembly are arranged to engage with the mating pads on adjacent cinematography battery packs upon magnetic coupling, establishing electrical and/or data communication continuity between the cinematography packs.

In use, to parallelize the cinematography battery packs, the cinematography battery packs are stacked upon each other in a desired configuration. As the cinematography battery packs are stacked, the magnetic connection pads on each cinematography battery pack attract and align with the corresponding pads on neighboring cinematography battery packs. Simultaneously or substantially simultaneously, the leaf spring-type connectors make electrical and/or data communication contact with the mating pads, completing the parallel connection.

Once stacked and connected, the cinematography battery packs form a parallel electrical pathway, allowing the combined energy storage capacity and output capability of the system to be utilized efficiently. That is, the stacked cinematography battery packs are configured to be charged and to discharge as a single electrical bank. The magnetic coupling assembly described herein facilitates low-resistance electrical connections, minimizing power losses and optimizing system performance.

Unless otherwise indicated herein, each of the battery packs described have the same configuration as each other, and any number of such battery packs can be stacked and both mechanically and electrically connected with each other, as described herein. Thus, duplicative descriptions may be omitted.

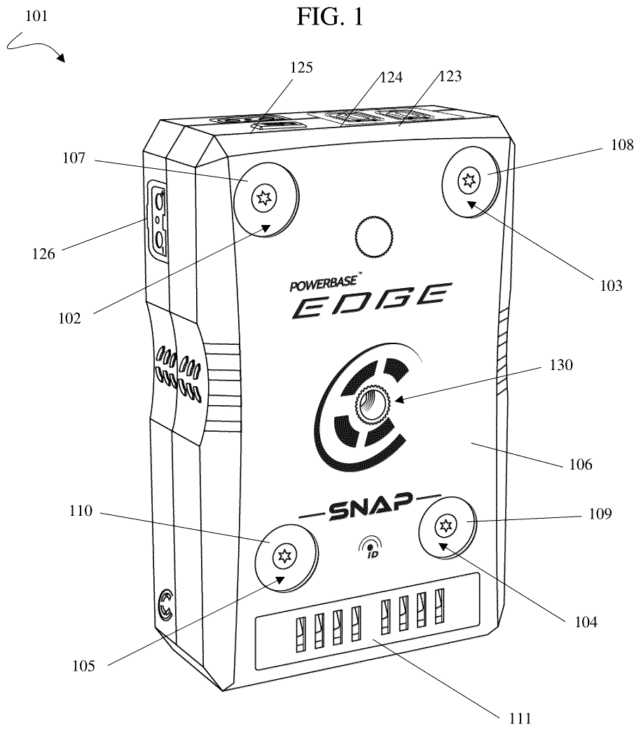

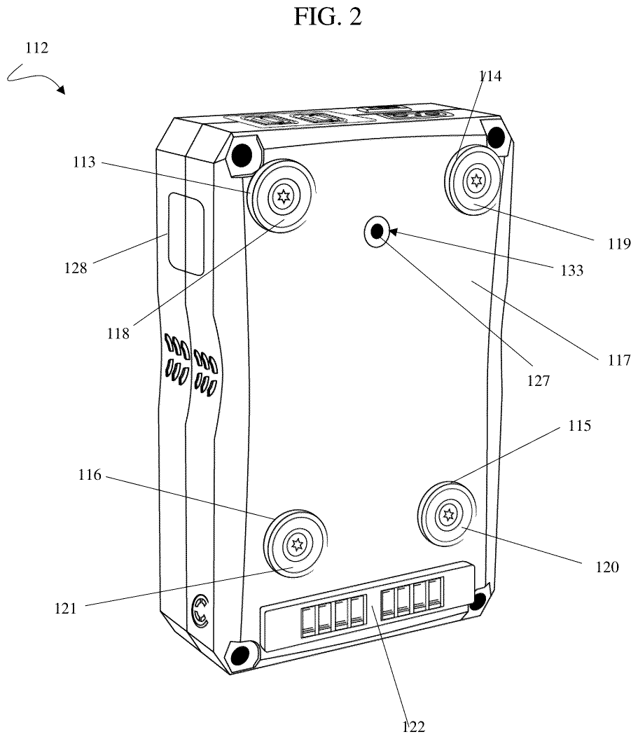

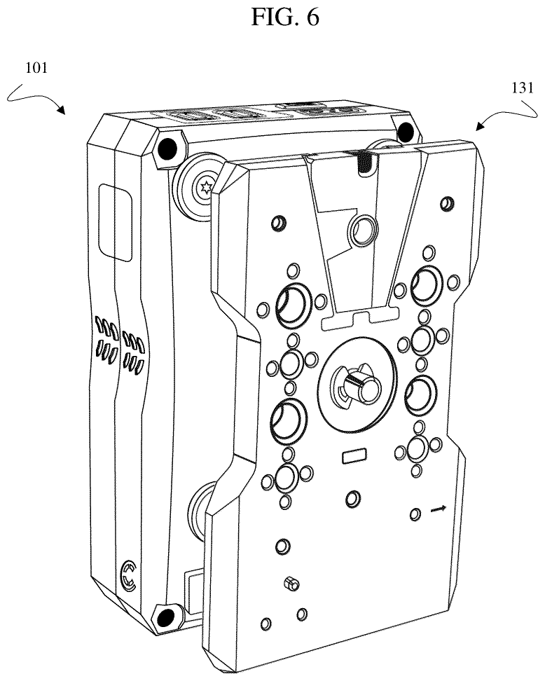

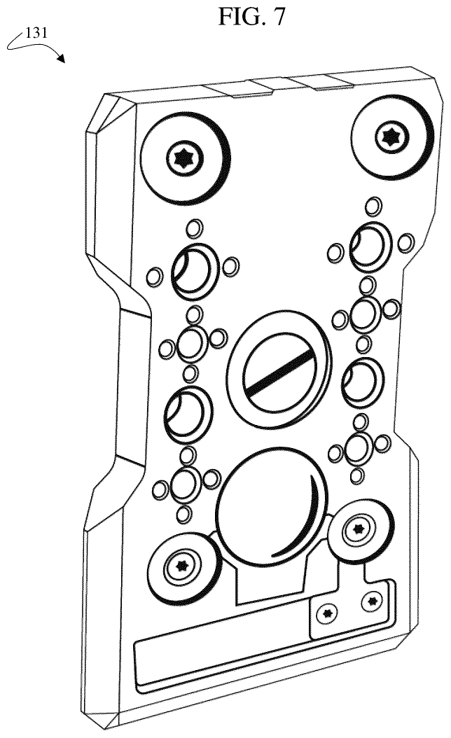

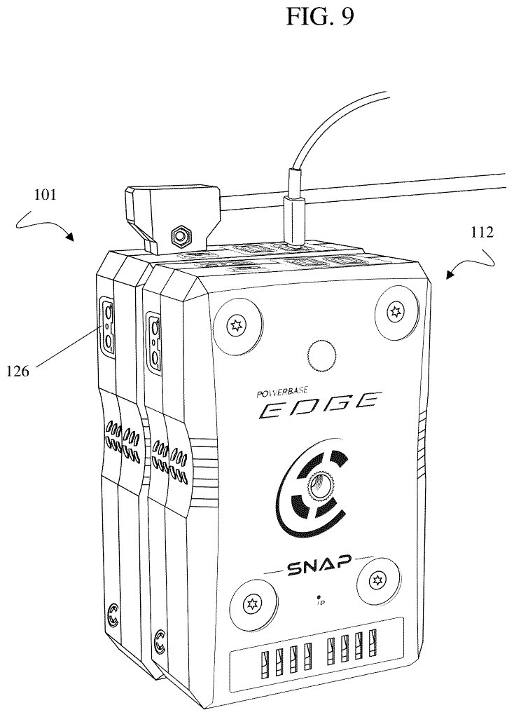

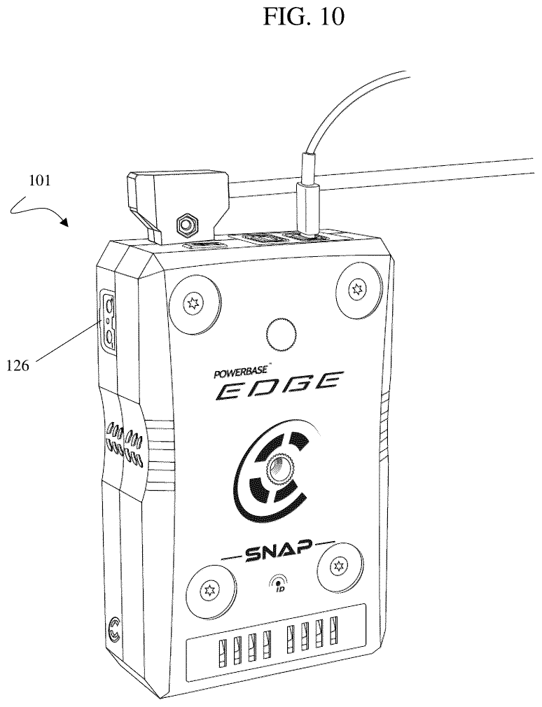

Referring to FIGS. 1 to 12, a system (e.g., system 100) for parallel charging and discharging of multiple cinematography battery packs includes a first cinematography battery pack 101. The first cinematography battery pack 101 includes at least two orifices (see, e.g. orifices 102, 103, 104 and 105 in FIG. 1) defined in a first surface 106 of the first cinematography battery pack 101. A first metal or magnetic member (see, e.g., metal or magnetic members 107, 108, 109, and 110 in FIG. 1) is arranged in each of the orifices. A female electrical connection 111 is supported by the first surface 1006 of the first cinematography battery pack 101. A second cinematography battery pack 112 is configured to be electrically and mechanically connected with the first cinematography battery pack 101. The second cinematography battery pack 112 includes at least two projections (see, e.g., projections 113, 114, 115, and 116 in FIG. 2) extending from a second surface 117 of the second cinematography battery pack 112. A second metal or magnetic member (see, e.g., metal or magnetic members 118, 119, 120, and 121 in FIG. 2) is supported by each of the projections. Each second metal or magnetic member is configured to connect with the corresponding first metal or magnetic member to magnetically connect the first cinematography battery pack 101 with the second cinematography battery pack 112. A male electrical connection 122 is supported by the second surface 117 of the second cinematography battery pack 112. The male electrical connection 122 is configured to be received in the female electrical connection 111 to electrically connect the first cinematography battery pack 101 with the second cinematography battery pack 112. At least one power port (see, e.g., power ports 123, 124, 125, and 126) is defined in the first cinematography battery pack 101 or the second cinematography battery pack 112. The power port is configured to charge the first cinematography battery pack 101 and the second cinematography battery pack 112 in a parallel arrangement by a single source of electrical power. The power port is also configured to discharge the first cinematography battery pack 101 and the second cinematography battery pack 112 in the parallel arrangement.

A shape, size, and dimensions of each of the orifices, protrusions and magnets are arranged to correspond with each other. That is, the orifices are shaped to receive the protrusions therein (e.g., to prevent lateral movement of the cinematography battery packs with respect to each other). As an example, each of the protrusions and orifices may define a circular, cylindrical, or tubular shape.

A shape defined by the magnetic or metal members may be circular, cylindrical, or donut shaped. A size defined by each of the metal or magnetic members may be arranged so that the metal or magnetic member fit into the orifices or at a distal-facing end of the projections. The projections may also be referred to as posts or protrusions, and the orifices may also be referred to as indents or recesses. In use, the metal or magnetic members may be arranged to directly contact each other. The metal or magnetic members may each be secured to the corresponding projection or orifices by a connecting member, such as a screw, grommet, or the like.

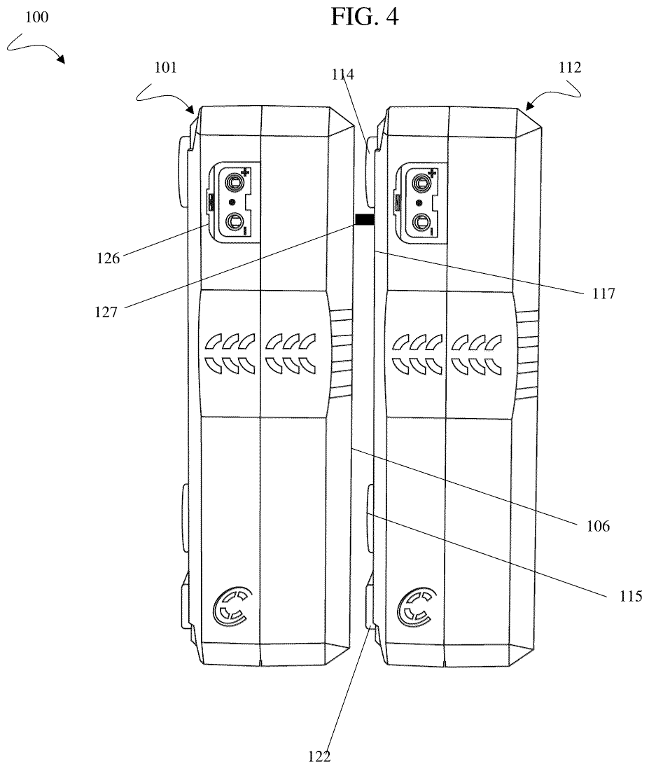

Referring particularly to FIGS. 2 to 4, an actuatable post 127 is arranged in the second cinematography battery pack 112. The actuatable post 127 is configured to be actuated between a first retracted position (see, e.g., FIG. 4) and a second extended position (see, e.g., FIG. 4). An actuation button 128 is arranged in the second cinematography battery pack 112. The actuation button 128 is operably coupled with the actuatable post 127. The actuation button 128 is configured to actuate the actuatable post 127 between the first retracted position and a second extended position. Upon actuation of the actuatable post 127 to the extended position, the actuatable post 127 pushes against the first surface 106 of the first cinematography battery pack 101 to separate the first cinematography battery pack 101 from the second cinematography battery pack 112.

In use, depressing the actuation button 128 causes actuation of the actuatable post 127 which applies pressure to adjacent cinematography battery pack to separate the first cinematography battery pack 101 from the second cinematography battery pack 112. The actuatable post 127 makes separating cinematography battery packs easier by at least partially mechanically separating cinematography battery packs from each other without the need for a user to manually apply enough force to break the magnetic connection between the cinematography battery packs. The actuatable post 127 may partially separate the cinematography battery packs from each, such as by breaking the magnetic connection between two orifices/posts but maintaining the magnetic connection between two other orifices/posts, such that final separation of the cinematography battery packs is achieved though the application of manual force by a user. Thus, separating the cinematography battery packs can occur in two steps, first by the actuation of the actuatable post 127 to partially separate the cinematography battery packs, and second by a user manually applying a mechanical force (e.g., by pulling the cinematography battery packs apart) to complete the separation of the cinematography battery packs.

The actuatable post 127 may be offset from a center of the corresponding cinematography battery pack. The actuatable post 127 may be arranged in a recess or orifice 133. A distal-most end of the actuatable post may be flush with an outer surface of the corresponding cinematography battery pack. The actuatable post 127 may define a cylindrical shape, for example.

Referring particularly to FIGS. 1 and 8 to 10, each cinematography battery pack may include a number of charging ports (see, e.g., power ports 123, 124, 125, and 126) arranged about the cinematography battery pack. Each charging port configured to power an accessory product such as a camera (i.e., to discharge the cinematography battery pack or stacked cinematography battery packs in a parallel arrangement). Each charging port is also configured to charge the cinematography battery packs or stacked cinematography battery packs in a parallel arrangement.

As an example, the charging ports (see, e.g., power ports 123, 124, 125, and 126) may include a USB-C PD power port or a DTAP port, or a number of each type of ports. Other USB ports may also be included in the cinematography battery packs (e.g., USB-A, etc.).

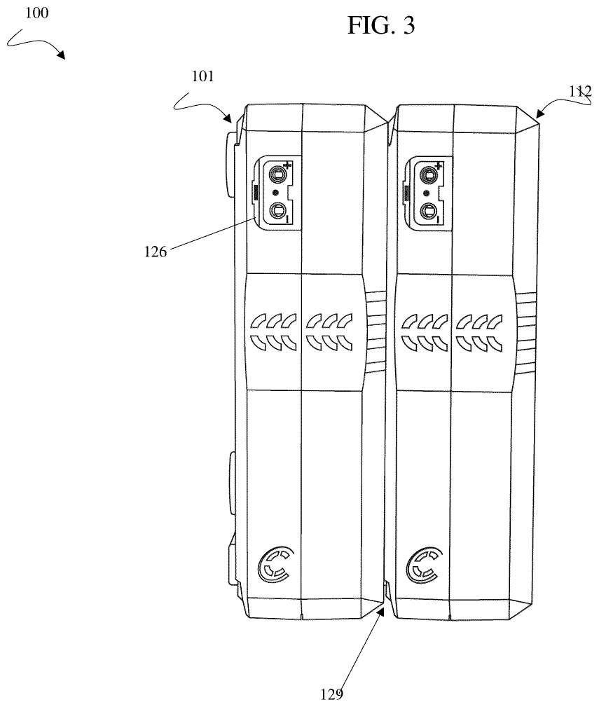

In an aspect of the present disclosure, the female electrical connection 111 and the male electrical connection 122 define an electrical power connection assembly 129 (see, e.g., FIG. 3). The electrical connection assembly 129 is configured to transmit electrical power and data.

For example, the female electrical connection 111 and the male electrical connection 122 define a leaf spring electrical connection assembly.

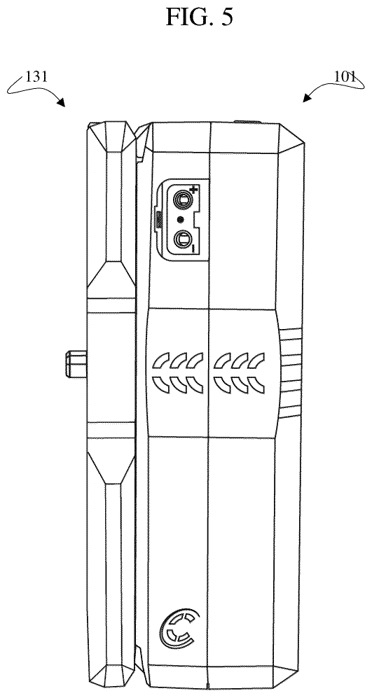

Referring particularly to FIGS. 5 to 7, 11 and 12, a fastening orifice 130 is defined in the first surface 106 of the first cinematography battery pack 101. The fastening orifice 130 is configured to couple the first cinematography battery pack 101 with another structure.

As an example, the fastening orifice 130 may be a threaded bore configured to receive a connecting member, such as a screw or bolt therein.

In an aspect of the present disclosure, a fastening plate 131 is configured to connect with the first cinematography battery pack 101 or the second cinematography battery pack 112.

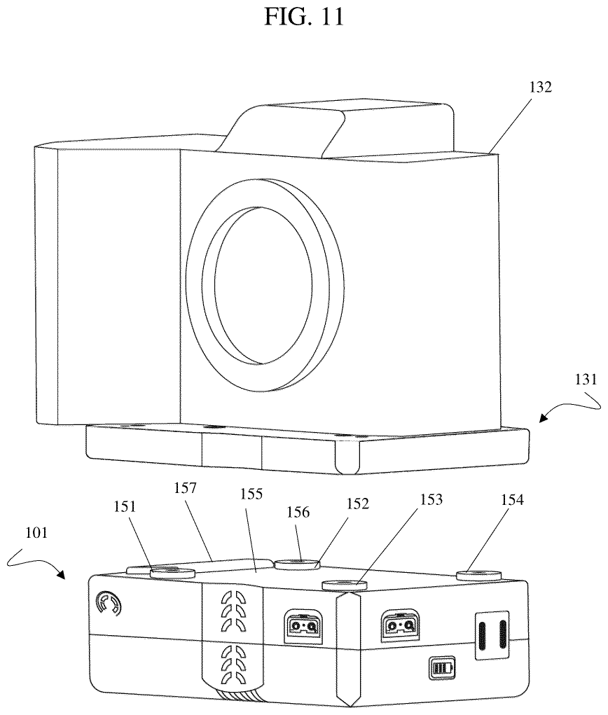

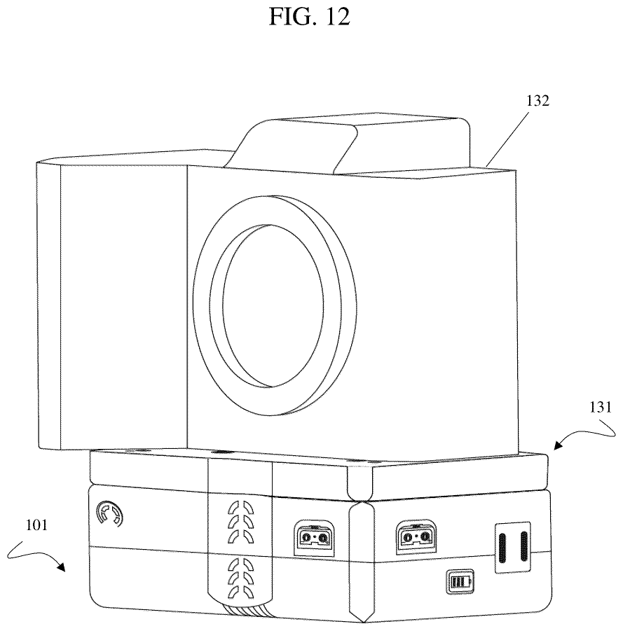

In use, the fastening plate 131 is configured to mechanically and/or electrically connect with a cinematography device (see, e.g., camera 132 in FIGS. 11 and 12). The fastening plate 131 is configured to form a mechanical and/or electrical connection between the first cinematography battery pack 101 or the second cinematography battery pack 112 and the cinematography device. The fastening plate 131 may include orifices or projections corresponding with the orifices or projections of the cinematography battery packs.

In an aspect of the present disclosure, the at least two orifices include at least four orifices and the at least two projections include at least four projections. The orifices of the at least four orifices and the projections of the at least four projections are asymmetrically aligned with each other to form a directional orientation between the first cinematography battery pack 101 and the second cinematography battery pack 112. As an example, two of the orifices and projections may be relatively closer to a midline or center of the corresponding cinematography battery packs.

In an aspect of the present disclosure, the metal or magnetic members of each of the at least four orifices and the at least four projections each define a polarity. The polarity of the metal or magnetic members of each of the at least four orifices and the at least four projections is arranged to prevent misalignment between the first cinematography battery pack 101 and the second cinematography battery pack 112.

Referring generally to FIGS. 1 to 12, a cinematography battery pack 101 for parallel charging and discharging with other cinematography battery packs includes at least two orifices defined in a first surface of the cinematography battery pack. A first metal or magnetic member is arranged in each of the at least two orifices. A female electrical connection is supported by the first surface of the cinematography battery pack. at least two projections extend from a second surface of the cinematography battery pack. A second metal or magnetic member is supported by each of the at least two projections. Each second metal or magnetic member is configured to connect with the corresponding first metal or magnetic member to magnetically connect the cinematography battery pack with at least one other cinematography battery pack. A male electrical connection is supported by the second surface of the cinematography battery pack. The male electrical connection is configured to be received in the female electrical connection of the other cinematography battery pack to electrically connect the cinematography battery pack with the other cinematography battery pack. At least one power port is defined in the cinematography battery pack. The power port is configured to charge the cinematography battery pack and the other cinematography battery pack in a parallel arrangement by a single source of electrical power connected with the cinematography battery pack. The power port is also configured to discharge the cinematography battery and the other cinematography battery pack in the parallel arrangement.

Referring particularly to FIGS. 2 to 4, an actuatable post (see, e.g., post 127) is arranged in the cinematography battery pack 101.

The actuatable post is configured to be actuated between a first retracted position and a second extended position. An actuation button is arranged in the cinematography battery pack. The actuation button is operably coupled with the actuatable post. The actuation button is configured to actuate the actuatable post between the first retracted position and a second extended position. Upon actuation of the actuatable post to the extended position, the actuatable post pushes against another cinematography battery pack to separate the cinematography battery pack from the other cinematography battery pack.

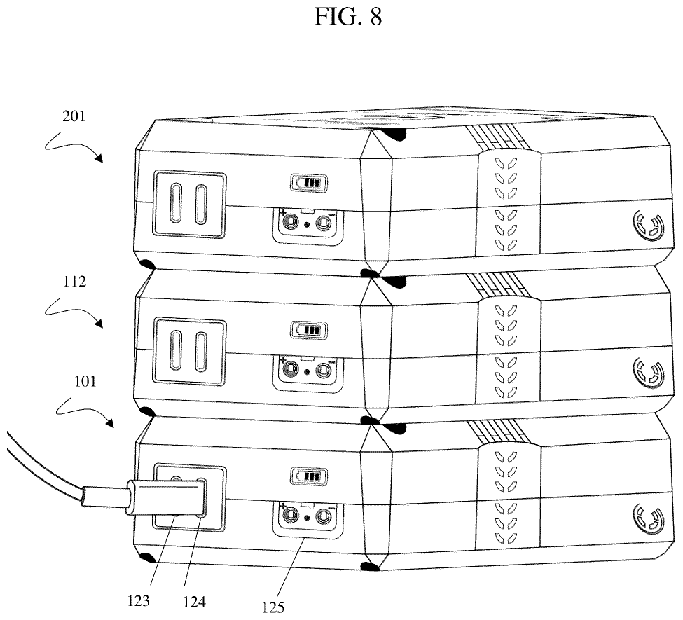

In use, the flow of electrical current between the cinematography battery packs may be controlled by at least one onboard MCU of a cinematography battery pack. For example, the MCU of the one battery pack in the stack connected with a charging cable (e.g., a USB-C charging cable as in FIG. 8) can be selected as the governing MCU to control the flow of electrical charging power to the other battery packs in the stack. Thus, power can be distributed until each partially charged battery pack in the stack has approximately the same level of charge. When the charge levels have been approximately or substantially equalized between the battery packs, the electrical charging power can then be evenly distributed between the battery packs to power or charge the battery packs. As an example, the electrical charging power can pass through a first battery in a stack and into the second battery in the stack, and the electrical charging power can further pass through the second battery in the stack and into the third battery in the stack such that each of the batteries (e.g., three batteries 101, 112, and 201 of system 100 as illustrated in FIG. 8) is charged at substantially the same rate.

During the process of equalizing the initial charge level of the battery packs, the electrical power stored in one battery can be passed to another battery in the stack. For example, a fully charged first battery in a stack might be at least partially used to charge two additional batteries in the stack the are fully depleted. In this example, if no external source of charging power is provided, a fully charged first battery connected with two completely drained second and third batteries would result in a stack with three battery packs that are each approximately ⅓ charged. Thus, when a source of external charging power is provided, each of the battery packs can then be charged at substantially the same rate, as described or incorporated by reference herein.

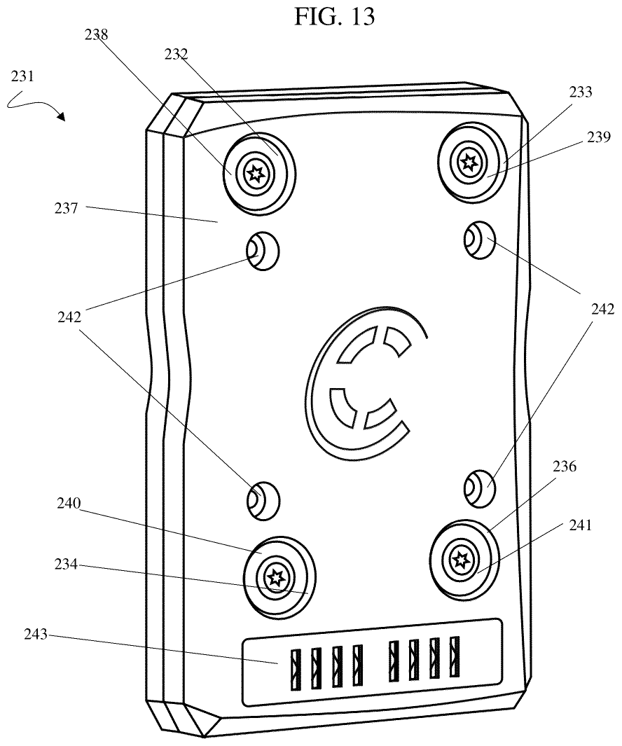

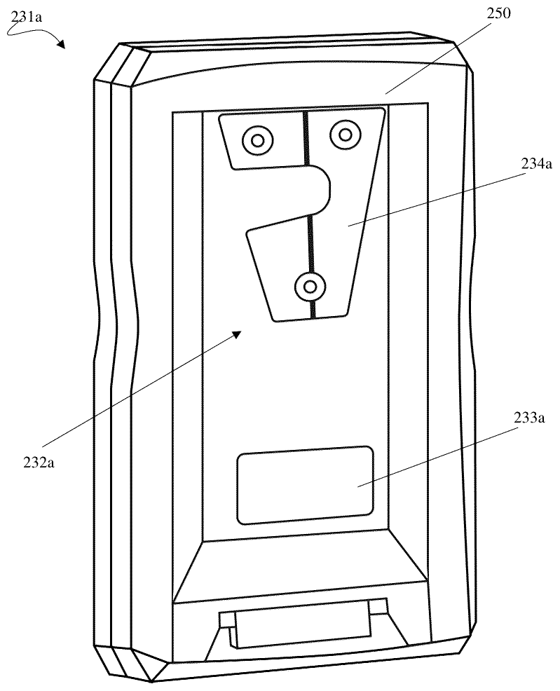

Referring now to FIGS. 13 to 17, other aspects of fastening plates are shown. The fastening plates (collectively “fastening plates 231”) of FIGS. 13-17 share several similarities to the fastening plate 131 described herein. In the interest of brevity and clarity, some of the similarities between the fastening plate 131 and the fastening plates 231 will not be described in detail. Additionally, each of the fastening plates 231a-231c in FIGS. 15-17 have the same or similar first surface 237 as the first surface 237 of the fastening plate 231 shown in FIG. 13, and a different second surface 250 from each other. Additionally, while the description below indicates that the fastening plates 231 are configured to connect with the first cinematography battery pack 101, the fastening plates 231 are also configured to connect with the second cinematography battery pack 112, for instance.

With particular reference to FIGS. 13, the first surface 237 of the fastening plate 231 is shown. The fastening plate 231 is configured to connect with the first cinematography battery pack 101, and is configured to connect with a cinematography device 132 (see, e.g., a camera in FIGS. 11 and 12). More particularly, the fastening plate 231 is configured to mechanically and electrically connect with the first cinematography battery pack 101, and is configured to mechanically and electrically connect with the cinematography device 132. The fastening plate 231 is also configured to transmit data between the first cinematography battery pack 101 and the cinematography device 132, such as through an SMBUS connection.

The fastening plate 231 includes a plurality of orifices (see, e.g., orifices 232, 233, 234, 236 in FIG. 13) defined in the first surface 237 of the fastening plate 231. A first metal or magnetic member (see, e.g., metal or magnetic members 238, 239, 240, 241 in FIG. 13; collectively referred to herein as “magnetic member 238” or “magnetic members 238”) is arranged in each of the orifices. Additionally, a plurality of through holes 242 extend through the fastening plate 231 to allow the fastening plate 231 to be mechanically connected with the cinematography device 132 having corresponding holes, for instance, such as by employing a number of screws or bolts.

The first cinematography battery pack 101 includes a plurality of projections (see, e.g., projections 151, 152, 153, 154 in FIG. 11) extending from a second surface 155 of the first cinematography battery pack 101 and corresponding with the orifices 232, 233, 234, 236 of the fastening plate 231. A metal or magnetic member (see, e.g., metal or magnetic member 156 in FIG. 11) is supported by each of the projections. Each metal or magnetic member 156 of the first cinematography battery pack 101 is configured to magnetically connect with or engage the corresponding magnetic member 238 of the fastening plate 231 to magnetically connect the first cinematography battery pack 101 with the fastening plate 231.

The fastening plate 231 includes a first (e.g., female) electrical connection 243 that is supported by the first surface 237 of the fastening plate 231. The first electrical connection 243 of the fastening plate 231 is configured to electrically connect to a corresponding (e.g., male) electrical connection 157 (see FIG. 11) of the first cinematography battery pack 101.

In an aspect of the present disclosure, the first electrical connection 243 of the fastening plate 231 and the corresponding electrical connection 157 of the first cinematography battery pack 101 define an electrical power connection assembly, which is configured to transmit electrical power and data. For example, the first electrical connection 243 of the fastening plate 231 and the corresponding electrical connection 157 of the first cinematography battery pack 101 define a leaf spring electrical connection assembly.

Accordingly, mechanical engagement between the fastening plate 231 and the first cinematography battery pack 101 also results in an electrical engagement between the fastening plate 231 and the first cinematography battery pack 101.

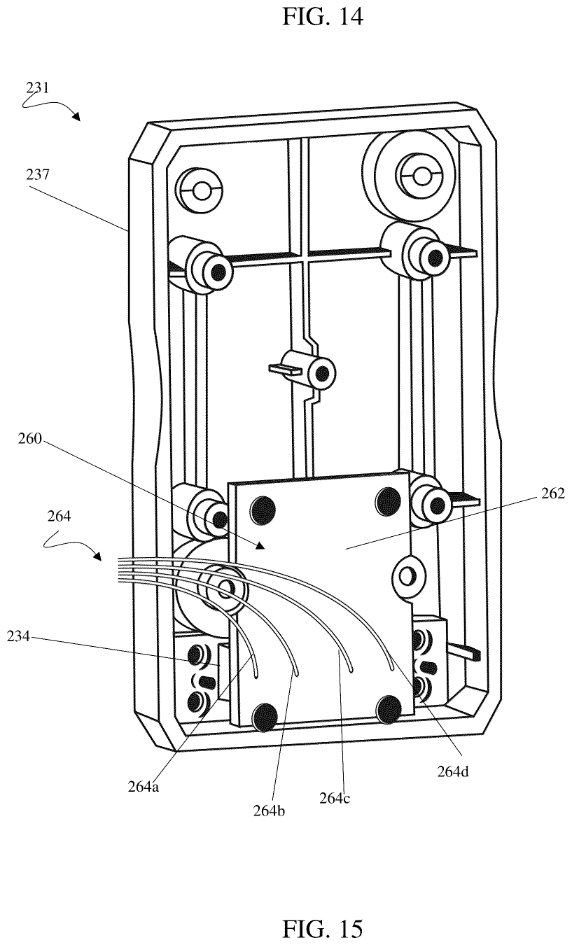

Referring now to FIG. 14, internal components of the fastening plate 231 are shown. In particular, a second electrical connection 260 of the fastening plate 231 is shown and is electrically coupled to the first electrical connection 243 of the fastening plate 231. The second electrical connection 260 includes a printed circuit board 262 and a plurality of wires 264 engaged therewith, which can function as an electrical interconnect. In the illustrated aspect, the plurality of wires 264 includes a first wire 264a (e.g., a negative wire), a second wire 264b (e.g., a SDA smart battery connection), a third wire 264c (e.g., a SCL smart battery connection), and a fourth wire 264d (e.g., a positive wire). The free ends of the wires 264 can be terminated with an appropriate connector or directly soldered to the cinematography device 132, for example.

The second electrical connection 260 is configured to electrically engage an electrical connection of the cinematography device 132. Thus, the fastening plate 231 is configured to receive electrical power and data from the first cinematography battery pack 101, and is configured to transmit electrical power and data to the cinematography device 132.

Referring now to FIGS. 15 to 17, different aspects of the second surface 250 of the fastening plate 231 are shown. Each illustrated aspect includes a different mount arrangement configured to mechanically engage the cinematography device 132. That is, the embodiments described below with reference to FIGS. 15 to 17 enable the fastening plate 231 to operate as an adapter between the cinematography device 132 and the magnetic/electrical connections described herein.

With initial regard to FIG. 15, a fastening plate 231a having a V-mount adapter 232ais shown. The V-mount adapter 232a includes a V-mount electrical terminal block 233a, and a V-shaped bracket 234a. The fastening plate 231a is configured to mechanically and electrically engage a cinematography device 132 that includes features for engaging a V-mount battery, for instance.

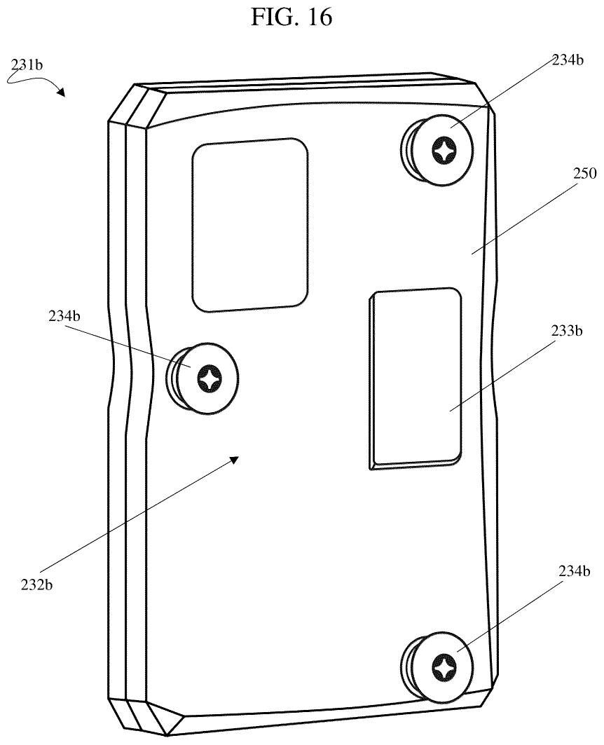

Referring now to FIG. 16, a fastening plate 231b having a G-mount adapter 232b is shown. The G-mount adapter 232b includes a G-mount electrical terminal block 233b, and a plurality of locating pins 234b. The fastening plate 231b is configured to mechanically and electrically engage a cinematography device 132 that includes features for engaging a G-mount battery, for instance.

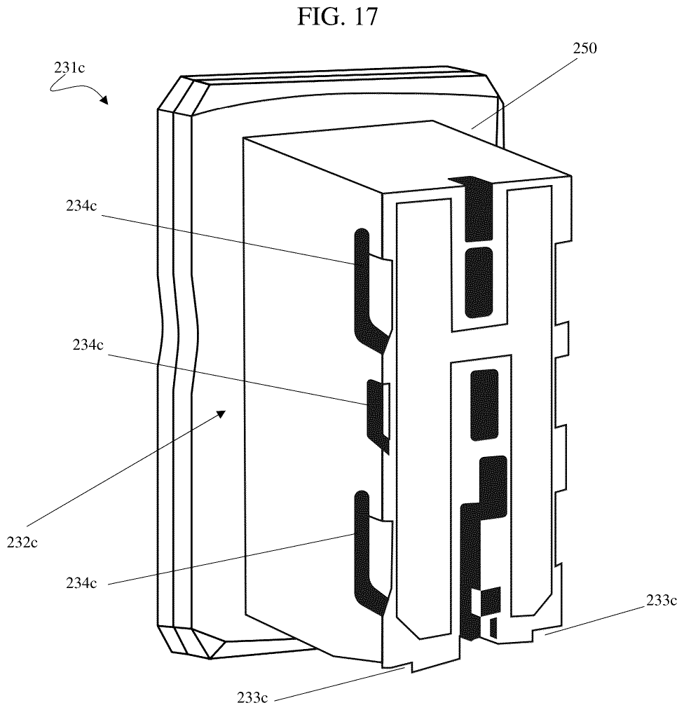

Referring now to FIG. 17, a fastening plate 231c having a camcorder battery interface 232c (e.g., a camcorder adapter) is shown. The camcorder battery interface 232c includes electrical terminals 233c, and a plurality of mechanical engagement features 234c. The fastening plate 231c is configured to mechanically and electrically engage a cinematography device 132 that includes features for engaging a B-mount battery or a camcorder, for instance.

A shape, size, and dimensions of each of the orifices, protrusions and magnets are arranged to correspond with each other. That is, the orifices are shaped to receive the protrusions therein (e.g., to prevent lateral movement of the cinematography battery packs with respect to each other). As an example, each of the protrusions and orifices may define a circular, cylindrical, or tubular shape.

A shape defined by the magnetic or metal members may be circular, cylindrical, or donut shaped. A size defined by each of the metal or magnetic members may be arranged so that the metal or magnetic member fit into the orifices or at a distal-facing end of the projections. The projections may also be referred to as posts or protrusions, and the orifices may also be referred to as indents or recesses. In use, the metal or magnetic members may be arranged to directly contact each other. The metal or magnetic members may each be secured to the corresponding projection or orifices by a connecting member, such as a screw, grommet, or the like.

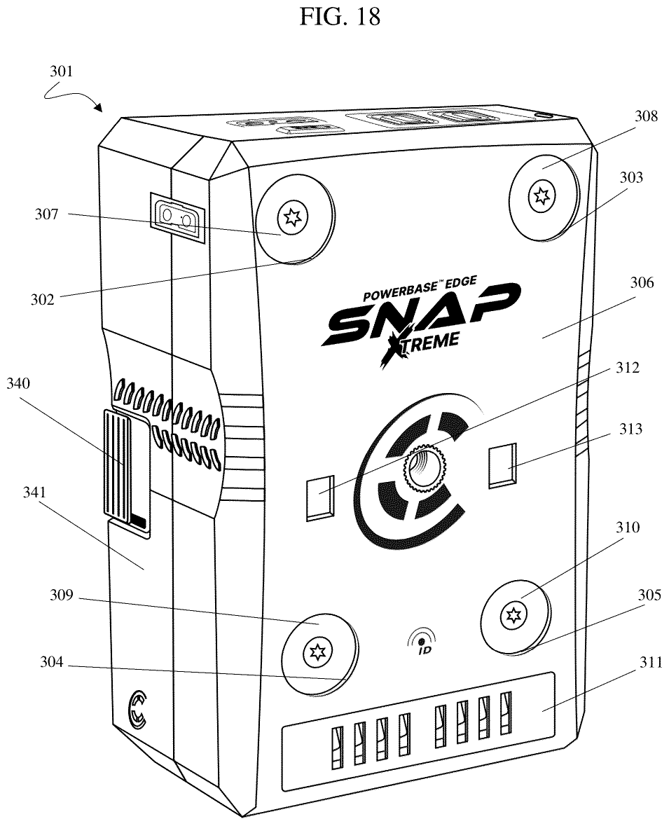

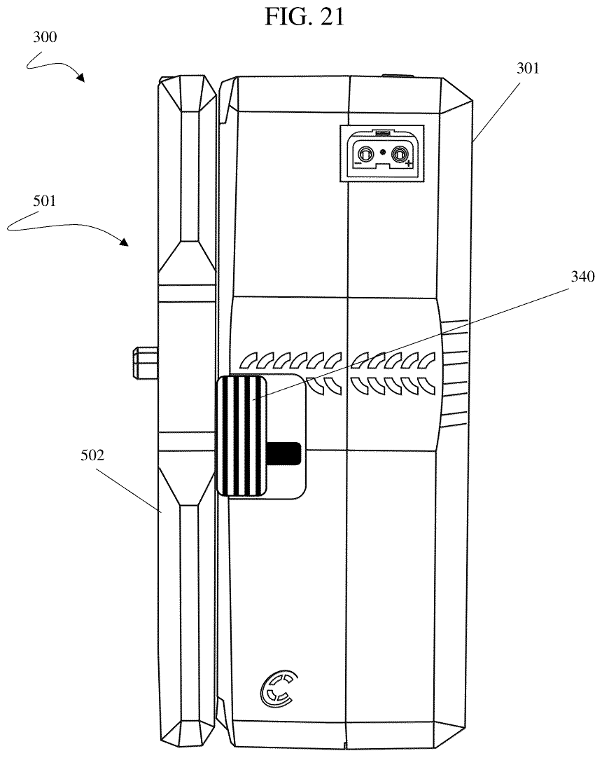

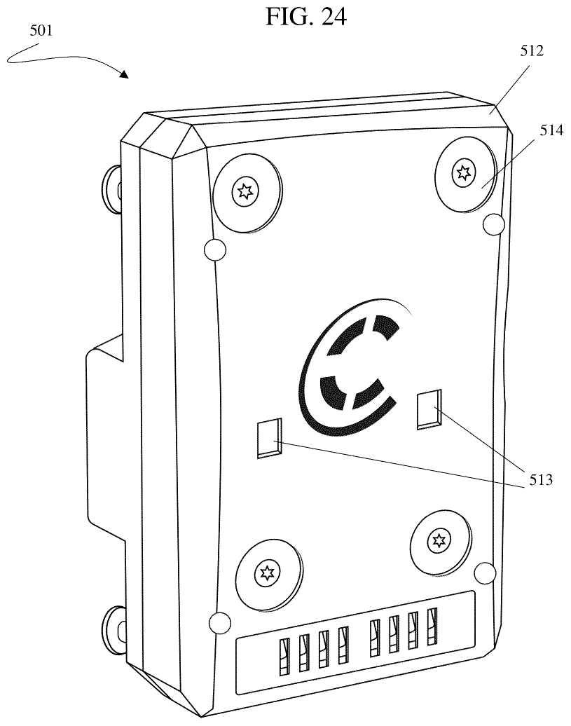

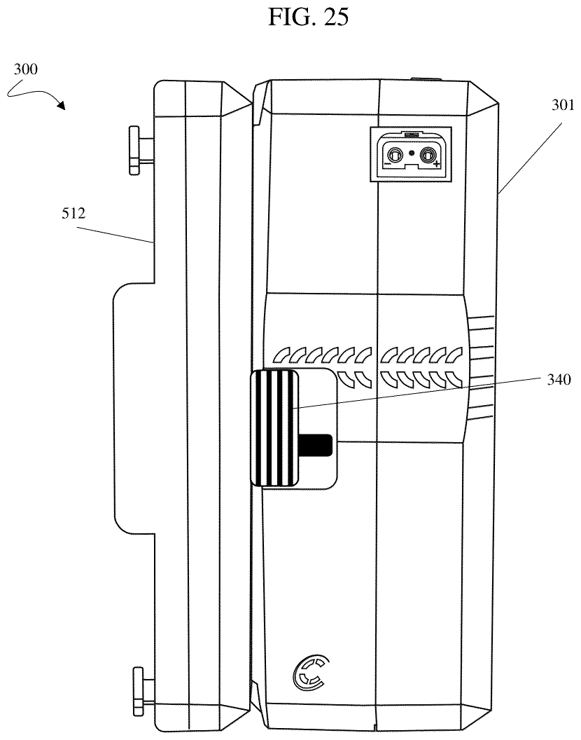

Referring now to FIGS. 18 to 26, an embodiment of a system (e.g., system 300) for enabling cinematography battery packs and accessories (e.g., adapters, quick-release plates) to engage with each other magnetically and mechanically is shown. The system 300 includes a first cinematography battery pack 301, a second cinematography battery pack 401, and/or a cinematography accessory 501 (e.g., mounting plate 502 in FIG. 21 or adapter 512 in FIG. 24). In the interest of brevity and clarity, only the first cinematography battery pack 301 will be described in detail herein. The first cinematography battery pack 301 and the second cinematography battery pack 401 are generally identical unless otherwise specified.

The first cinematography battery pack 301 includes at least two orifices (see, e.g. orifices 302, 303, 304 and 305 in FIG. 18) defined in a first surface 306 of the first cinematography battery pack 301. A first metal or magnetic member (see, e.g., metal or magnetic members 307, 308, 309, and 310 in FIG. 18) is arranged in each of the orifices. A female electrical connection 311 is supported by the first surface 306 of the first cinematography battery pack 301. The first surface 306 of the first cinematography battery pack 301 also defines at least one latch receiver (e.g., two latch receivers 312, 313 in FIG. 18).

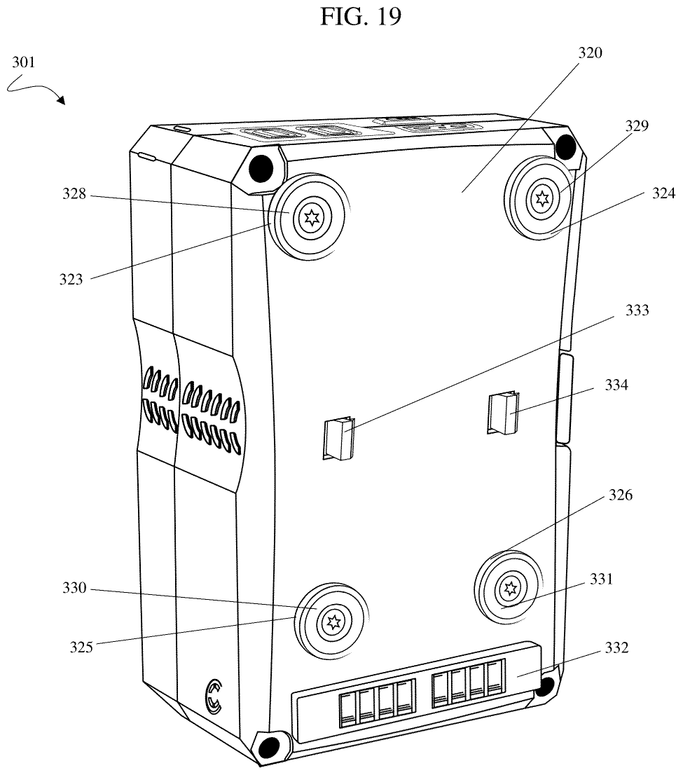

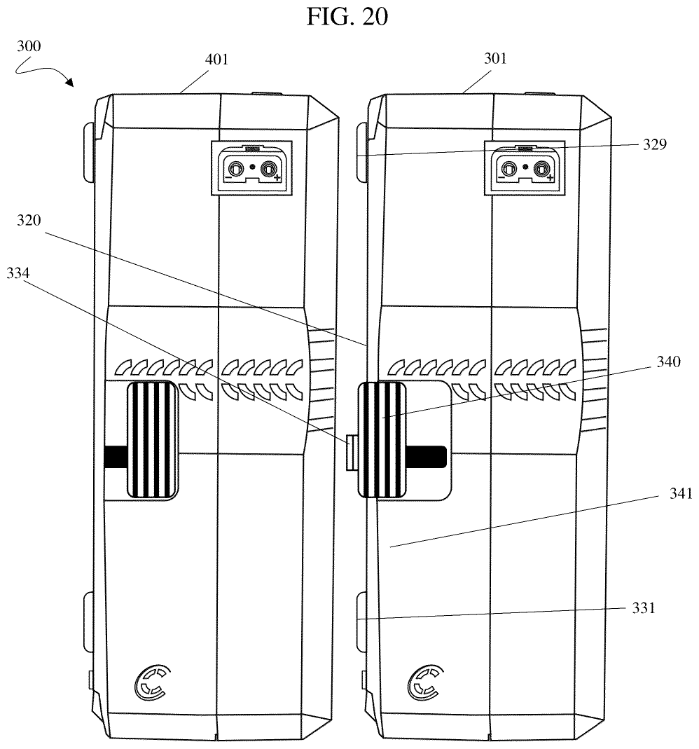

With particular reference to FIG. 19, a second surface 320 of the first cinematography battery pack 301 is shown. The second surface 320 includes at least two projections (see, e.g., projections 323, 324, 325, and 326 in FIG. 19) extending therefrom. A second metal or magnetic member (see, e.g., metal or magnetic members 328, 329, 330, and 331 in FIG. 19) is supported by each of the projections. Each second metal or magnetic member on the second surface 320 of the first cinematography battery pack 301 is configured to magnetically engage a corresponding first metal or magnetic member of a second cinematography battery pack 401 (FIG. 20) or of a cinematography accessory 501 (e.g., mounting plate 502 in FIG. 21 or adapter 512 in FIG. 24). Additionally, a male electrical connection 332 is supported by the second surface 320 of the first cinematography battery pack 301. The male electrical connection 332 is configured to be received in a female electrical connection of the second cinematography battery pack 401 (FIG. 20) or the cinematography accessory 501 (e.g., mounting plate 502 in FIG. 21 or adapter 512 in FIG. 24) to electrically connect the first cinematography battery pack 301 with the second cinematography battery pack 401 or the cinematography accessory 501.

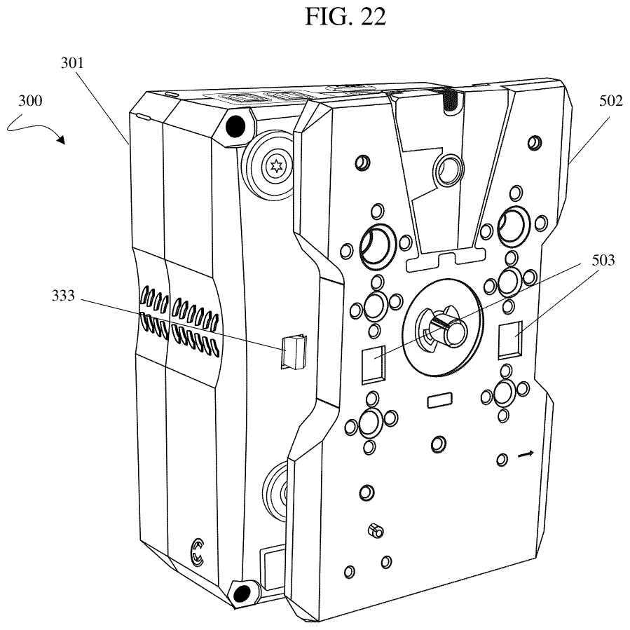

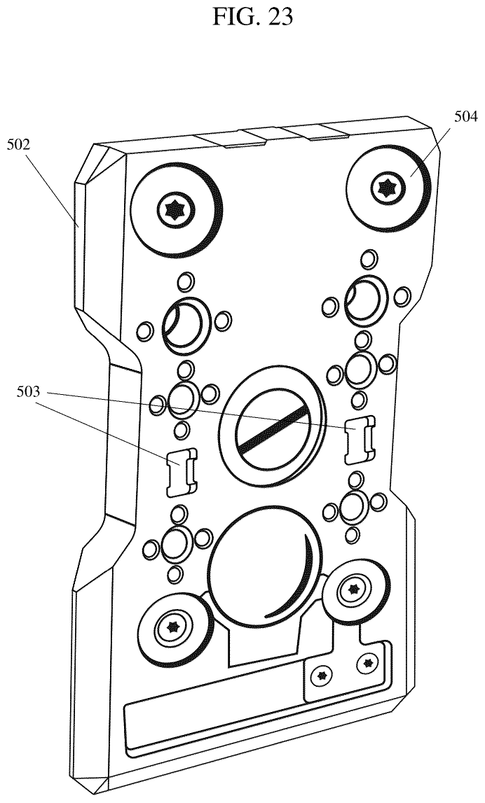

Further, the second surface 320 of the first cinematography battery pack 301 includes at least one latch (e.g., two latches 333, 334 in FIG. 19). While two latches 333, 334 are shown, the first cinematography battery pack 301 may include more or fewer than two latches. Each latch 333, 334 is configured to selectively mechanically engage the latch receiver of the second cinematography battery pack 401 (FIG. 20) or the cinematography accessory 501 (e.g., mounting plate 502 in FIG. 21 or adapter 512 in FIG. 24) to mechanically connect the first cinematography battery pack 301 with the second cinematography battery pack 401 or the cinematography accessory 501. The latch receivers of the mounting plate 502 are indicated by reference character 503 in FIGS. 22 and 23, and the latch receivers of the adapter 512 are indicated by reference character 513 in FIG. 24.

The latches 333, 334 are movable (e.g., pivotable) between a first position (shown with regard to the second cinematography battery pack 401 in FIG. 20) where the latches 333, 334 (e.g., an entirety of the latches) are recessed below the second surface, and a second position (shown with regard to the first cinematography battery pack 301 in FIG. 20) where at least a portion of the latches 333, 334 protrudes beyond the second surface 320. An actuator 340 is shown on a first side surface 341 of the first cinematography battery pack 301 and is actuatable by a user to move between a first position (the second cinematography battery pack 401 in FIG. 20) and a second position (the first cinematography battery pack 301 in FIG. 20) to correspondingly move the latches 333, 334 between the first position and the second position. That is, movement of the actuator 340 from the first position to the second position causes each of the latches 333, 334 to move from the first position to the second position. Likewise, movement of the actuator 340 from the second position to the first position causes each of the latches 333, 334 to move from the second position to the first position.

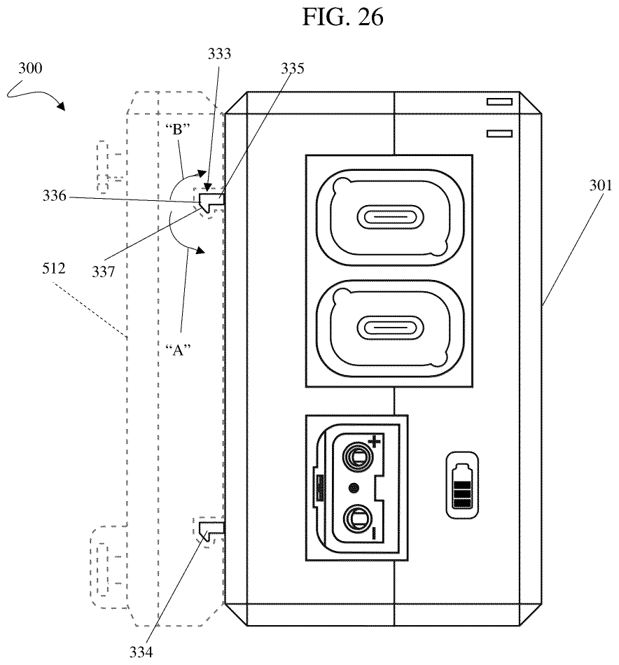

With particular reference to FIG. 26, the shape of the latches 333, 334 is shown in accordance with the illustrated embodiment. For ease of reference, the details of a single latch 333 are described, but the other latch 334 (or latches) are disclosed being the same or similar to the latch 333. As shown, the latch 333 includes a first leg 335, and a second leg 336 extending generally perpendicular from the first leg 335. Additionally, an engagement surface 337 of the second leg 336 is sloped or angled to facilitate engagement with the latch receiver, as described below.

Engagement between the first cinematography battery pack 301 and the second cinematography battery pack 401 or the cinematography accessory 501 when the latch 333 begins in the first position is described herein. Here, the magnetic members 328, 329, 330, and 331 of the first cinematography battery pack 301 are first magnetically engaged with the corresponding magnetic members of the second cinematography battery pack 401 or with corresponding magnetic members of the cinematography accessory 501 (a single magnetic member is indicated by reference character 504 in FIG. 23, and a single magnetic member is indicated by reference character 514 in FIG. 24). Next, the actuator 340 is moved from the first position to the second position causing the latch 333 to move from the first position to the second position. That is, the latch 333 moves or pivots in the general direction of arrow “A” (FIG. 26) into the second position such that the second leg 336 of the latch 333 is fully within the latch receiver, thereby fully engaging the latch 333 with the latch receiver of the second cinematography battery pack 401 or the cinematography accessory 501.

Engagement between the first cinematography battery pack 301 and the second cinematography battery pack 401 or the cinematography accessory 501 when the latch 333 begins in the second position is described herein. Here, the engagement surface 337 of the latch 333 is configured to contact or engage a portion of a wall defining the latch receiver during approximation of the first cinematography battery pack 301 and the second cinematography battery pack 401 or the cinematography accessory 501. This engagement may cause the latch 333 to move or pivot in the general direction of arrow “B” (FIG. 26) towards the first position of the latch 333. Continued approximation of the first cinematography battery pack 301 and the second cinematography battery pack 401 or the cinematography accessory 501 causes the latch 333 to move past a side wall of the latch receiver and then move or pivot in the general direction of arrow “A” (FIG. 26) into the second position such that the second leg 336 of the latch 333 is fully within the latch receiver, thereby fully engaging the latch 333 with the latch receiver of the second cinematography battery pack 401 or the cinematography accessory 501. In embodiments, the latch 133 is biased (e.g., spring-biased) in the general direction of arrow “A” towards its second position. Thus, when the actuator 340 begins in the second position, magnetic engagement between the first cinematography battery pack 301 and the second cinematography battery pack 401 or the cinematography accessory 501 automatically causes the latches 333, 334 to mechanically engage the latch receivers.

Thus, mechanical engagement between the first cinematography battery pack 301 and the second cinematography battery pack 401 or the cinematography accessory 501 is possible both when the latches 333, 334 begin in the first position and when the latches 333, 334 begin in the second position. In addition to the magnetic connections between components of the system 300, the additional mechanical engagement between components of the system 300 allows for a more robust, secure, and/or reliable mechanism for attachment.

To mechanically disengage the first cinematography battery pack 301 from the second cinematography battery pack 401 or the cinematography accessory 501, the actuator 340 is moved from the second position to the first position, which causes the latches 333, 334 to move or pivot out of engagement from the latch receivers, thereby enabling disengagement of the first cinematography battery pack 301 from the second cinematography battery pack 401 or the cinematography accessory 501 (after overcoming the magnetic engagement therebetween).

Further, in addition to the mechanical engagement between the latches 333, 334 and the latch receivers, and the magnetic engagement between the magnetic members 328, 329, 330, and 331 of the first cinematography battery pack 301 with the corresponding magnetic members of the second cinematography battery pack 401 or with corresponding magnetic members of the cinematography accessory 501, the first cinematography battery pack 301 also electrically engages the second cinematography battery pack 401 or the cinematography accessory 501 with male electrical connection 332 engaging a corresponding female electrical connection of the second cinematography battery pack 401 or the cinematography accessory 501.

Additionally, since the latches 333, 334 are recessed below the second surface 320 of the first cinematography battery pack 301 when the latches 333, 334 are in the first position, the first cinematography battery pack 301 is still able to magnetically and/or electrically engage another cinematography battery pack or cinematography accessory that does not include latch receivers, as the latches 333, 334 would not interfere with such engagement.

Additionally, while the illustrated embodiments illustrate the first cinematography battery pack 301 engaged with one other element of the system 300, the disclosed system 300 also includes more than two cinematography battery packs that are engageable with each other at a time, in addition to being engageable with the cinematography accessory 501.

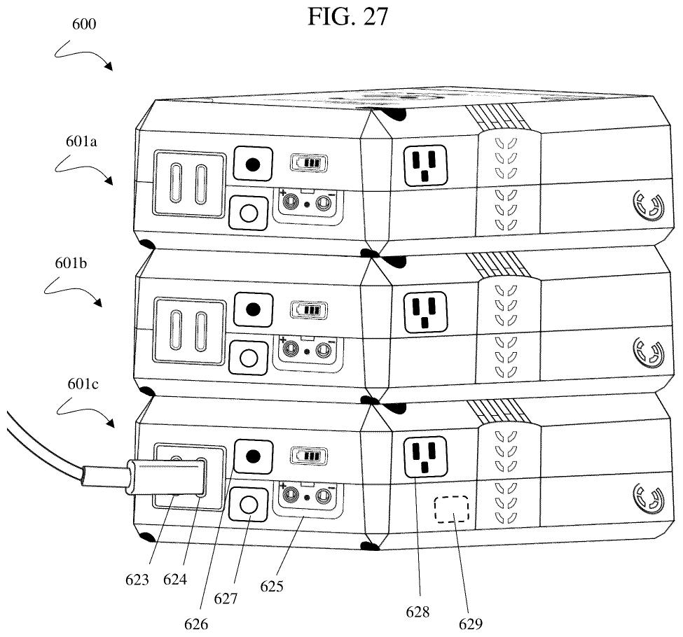

Referring now to FIG. 27, a battery system 600 is shown with regard to other aspects of the present disclosure. The battery system 600 includes a battery pack or a plurality of battery packs 601, shown as battery pack 601a, battery pack 601b, and battery pack 601c (collectively “battery packs 601”) that are engageable with each other. More particularly, the battery packs 601 of the system 600 are mechanically engageable with adjacent battery packs 601 of the system 600 (e.g., via a mechanical connection such as magnets, latches, etc., as discussed herein with regard to other aspects), and are electrically engageable via an electrical connection with adjacent battery packs 601 of the system 600 (as discussed herein with regard to other aspects). Moreover, the electrical connections between adjacent battery packs 601 are automatically made when one of the battery packs 601 is stacked or mechanically engaged with one another, thereby allowing multiple battery packs 601 to efficiently share a charge input source, for example. Further, while the battery packs 601 are shown as being cinematography battery packs, the battery packs 601 described herein have a wide range of uses across professional, communications, industrial, inspection, emergency response, mobile office setups, consumer electronics, and consumer markets beyond traditional cinematography applications.

Each battery pack 601 may include a number of charging ports and/or power ports (see, e.g., power ports 623, 624, 625, 626, 627, and 628) arranged about the battery pack 601. Each charging port is configured to power a product such as a camera, a radio, a lighting system, or a laptop computer, for instance. When a product or products are being charged, the battery pack 601 or stacked battery packs 601 are discharged in a parallel arrangement. The charging ports or power ports are also configured to charge the battery pack 601 or stacked battery packs 601 in a parallel arrangement.

As an example, the power ports (see, e.g., power ports 623, 624, 625, 626, 627, and 628) may include a USB-C PD power port or a DTAP port, or a number of each type of ports. Other USB ports may also be included in the battery packs 601 (e.g., USB-A, etc.). Further, as shown in FIG. 27, the power ports may include a DC input port 626, a DC output port 627, and an AC input port 628, for instance. Additionally, while a certain number of power ports are shown, the battery packs 601 may include more or fewer power ports without departing from the scope of this disclosure. With particular regard to the DC input port 626 and the DC output port 627, these power ports allow or facilitate flexible powering of DC-based external devices and/or charging from DC power sources.

Additionally, the battery packs 601 include an internal power inverter 629 (illustrated schematically in FIG. 27). In aspects, the power inverter 629 converts stored DC battery energy into AC output for providing power for AC-only devices. Further, in disclosed aspects, the power inverter 629 may be designed for AC output, without being able to support AC input charging. That is, the power inverter 629 may be unidirectional and configured for AC output only. However, the AC ports described herein may also be configured for AC input.

In aspects of the present disclosure, the power inverter 629 may be configured to convert AC input into DC for charging the battery pack.

Accordingly, the features of the battery system 600 described herein allow the battery system 600, and components thereof, to intelligently manage simultaneous DC and AC output power demands without disrupting device operation, thereby helping to ensure continuous and stable power delivery.

A USB-C PD connection device, system, and method are described in U.S. patent application Ser. No. 18/428,874, the entire contents of which are incorporated by reference herein.

An exemplary switching circuit for cinematography battery packs (e.g., battery pack 101) is described in U.S. Pat. No. 10,630,095, the entire contents of which are incorporated by reference herein. The switching circuit may be employed to switch the output voltage provided by cinematography battery pack 101.

Dual voltage battery packs are described in U.S. Pat. No. 11,735,841, the entire contents of which are incorporated by reference herein, and U.S. Pat. No. 11,770,012, the entire contents of which are incorporated by reference herein.

The battery packs described herein may be configured to connect with one or more battery mount plates. The battery mount plates described herein may be in the form of various battery mount arrangements, such as V-mount, G-mount, B-mount, or other arrangements configured to connect with a corresponding cinematography battery pack (e.g., cinematography battery pack 101) via an electromechanical connection. Mount plates having different mounting arrangements for connecting with different types of batteries is described in U.S. Pat. No. 10,197,630, the entire contents of which are incorporated by reference herein. A mount plate having various features is described in U.S. Pat. No. 10,841,492, the entire contents of which are incorporated by reference herein.

As an example, the magnets of the metal or magnetic members described herein may be neodymium magnets and the metal of the metal or magnetic member may be or may include steel, iron, nickel, or cobalt.

It will be understood that various modifications may be made to the aspects and features disclosed herein. Therefore, the above description should not be construed as limiting, but merely as exemplifications of various aspects and features. Those skilled in the art will envision other modifications within the scope and spirit of the claims appended thereto.

What is claimed is:

1. A battery pack, comprising:
a first mechanical connection configured to mechanically couple to a mechanical connection of an adjacent battery pack;
a first electrical connection configured to electrically couple to an electrical connection of the adjacent battery pack;
a DC input power port configured to allow charging from a DC power source;
a DC output power port configured to provide power to a DC-based device; and
an AC output power port configured to provide power to an AC-based device.

2. The battery pack according to claim 1, wherein the first electrical connection automatically electrically couples to the electrical connection of the adjacent battery pack upon the first mechanical connection mechanically engaging the mechanical connection of the adjacent battery pack.

3. The battery pack according to claim 1, wherein the first mechanical connection includes at least one magnet.

4. The battery pack according to claim 1, wherein the first mechanical connection includes at least one latch.

5. The battery pack according to claim 4, wherein the at least one latch is movable between a first position where the at least one latch is recessed below a surface of the battery pack, and a second position where at least a portion of the at least one latch protrudes from the surface of the battery pack.

6. The battery pack according to claim 4, further comprising a second mechanical connection configured to mechanically couple to another mechanical connection of the adjacent battery pack, wherein the second mechanical connection includes at least one magnet.

7. The battery pack according to claim 1, wherein the battery pack is a cinematography battery pack.

8. The battery pack according to claim 1, further comprising a power inverter configured to convert stored DC energy into AC output.

9. The battery pack according to claim 1, further comprising an additional power port, wherein the additional power port is a DTAP port or a USB port.

10. A battery system, comprising:
a first battery pack, including:
a first mechanical connection;
a first electrical connection;
a DC input power port configured to allow charging from a DC power source;
a DC output power port configured to provide power to a DC-based device; and
an AC output power port configured to provide power to an AC-based device; and
a second battery pack, including:
a second mechanical connection configured to mechanically couple to the first mechanical connection of the first battery pack;
a second electrical connection configured to electrically couple to the first electrical connection of the first battery pack;
a DC input power port configured to allow charging from a DC power source;
a DC output power port configured to provide power to a DC-based device; and
an AC output power port configured to provide power to an AC-based device.

11. The battery system according to claim 10, wherein the first battery pack and the second battery pack are configured to charge in parallel when the first battery pack and the second battery pack are mechanically coupled and electrically coupled with each other.

12. The battery system according to claim 10, wherein the first electrical connection of the first battery pack automatically electrically couples to the second electrical connection of the second battery pack upon the first mechanical connection of the first battery pack mechanically engaging the second mechanical connection of the second battery pack.

13. The battery system according to claim 10, wherein the first mechanical connection of the first battery pack includes at least one magnet, and wherein the second mechanical connection of the second battery pack includes at least one magnet.

14. The battery system according to claim 10, wherein the first mechanical connection of the first battery pack includes at least one latch, and wherein the second mechanical connection of the second battery pack includes at least one latch receiver.

15. The battery system according to claim 14, wherein the at least one latch is movable between a first position where the at least one latch is recessed below a surface of the first battery pack, and a second position where at least a portion of the at least one latch protrudes from the surface of the first battery pack.

16. The battery system according to claim 15, wherein the at least one latch of the first battery pack is configured to mechanically engage the latch receiver of the second battery pack when the at least one latch is in the second position.

17. The battery system according to claim 14, wherein the first battery pack includes a third mechanical connection configured to mechanically couple to a fourth mechanical connection of the second battery pack, wherein the third mechanical connection includes at least one magnet, and wherein the fourth mechanical connection includes at least one magnet.

18. The battery system according to claim 10, wherein the first battery pack is a cinematography battery pack, and wherein the second battery pack is a cinematography battery pack.

19. The battery system according to claim 10, wherein each of the first battery pack and the second battery pack includes a power inverter configured to convert stored DC energy into AC output.

20. The battery system according to claim 10, wherein each of the first battery pack and the second battery pack includes an additional power port, wherein the additional power port is a DTAP port or a USB port.
